(19) United States
(12) Patent Application Publication
(10) Pub. No.: US 2013/0241727 A1
(43) Pub. Date: Sep. 19, 2013

(54) DETECTION AND ALARM SYSTEM

(71) Applicant: Robert W. Coulombe, (US)

(72) Inventor: Robert W. Coulombe, (US)

(21) Appl. No.: 13/608,467

(22) Filed: Sep. 10, 2012

Related U.S. Application Data
(60) Provisional application No. 61/532,207, filed on Sep. 8, 2011.
(60) Provisional application No. 61/594,037, filed on Feb. 2, 2012.

(51) Int. Cl. G08B 23/00

(52) U.S. Cl. CPC G08B 23/00
USPC 340/517

(57) ABSTRACT

The present invention is directed to a detection and alarm system comprising at least one sensor configured to produce a first signal when a critical state is detected. The critical state is defined as the presence of a particular element specific to that particular sensor, for example, the presence of water when the sensor is water sensor. The detection and alarm system further includes a monitoring unit including a receiver and a transmitter. The receiver is configured to receive the first signal from the sensor, and the transmitter is configured to transmit a second signal when the receiver has received the first signal. The detection and alarm system also includes at least one notification device configured to receive the second signal from the transmitter and produce an alarm to notify a user of the critical state.

### CROSS REFERENCE TO RELATED APPLICATION

This application claims the benefit of U.S. Provisional Application 61/532,207, which was filed on Sep. 8, 2011, and U.S. Provisional Application 61/594,037, which was filed on Feb. 2, 2012, the disclosures of which are hereby incorporated by reference.

### BACKGROUND OF THE INVENTION

1. Field of the Invention

The present invention pertains to a detection and alarm system. More particularly, the present invention pertains to a detection and alarm system for use in a building, such as a house. Even more particularly, the present invention pertains to a system for detecting and alerting the presence of a water leak, carbon monoxide, smoke or fire, and so forth.

2. Description of the Prior Art

It is believed that water damage is the number one reason that homeowners file claims with their insurance companies. It is estimated that each year there are $9 billion in homeowner insurance policy losses due to water damage, which amounts to about 20% of all home insurance losses. The average water damage claim is thought to be about $4,000-$6,000.

Although a number of these claims arise from occurrences such as backed-up sewers resulting from rain, most of these insurance claims result from accidents occurring within the home. Some of these accidents are due to negligence. For example, a common accident occurs when a jar is placed in a sink under flowing hot water to loosen the jar's lid, only to have the jar plug the drain causing the sink to overflow. Other accidents can result from faulty plumbing in which a water connection may have been made improperly, or a pipe or fitting has broken due to corrosion, fatigue, etc.

In instances where a slow leak has occurred in a concealed area, the water can continue to leak for weeks or longer before the situation is realized by the homeowner. At that time, substantial wood rot may have occurred to the flooring material, the subfloor, as well as any ceiling, wall, or flooring material in the home beneath the leak.

When the leak is major, such as a broken water supply line to a dishwasher or a washing machine, tremendous damage can occur within a short amount of time. Although these leaks are not difficult to detect, they can quickly cause significant damage.

Because water damage is recognized as being expensive and problematic to homeowners and insurance providers alike, there have been numerous attempts in the prior art to provide a device which addresses this problem. For instance, there exist a number of patents which disclose devices capable of detecting the presence of water and providing an alarm which is audible and/or visible. Some of these devices are also capable of shutting off the water and/or gas supply lines to the leaking appliance (e.g., water heaters). Examples of these devices are disclosed in U.S. Pat. Nos. 6,157,307 to Hardin; 7,489,253 to Murphy; 6,639,517 to Chapman et al.; 6,873,263 to Hohman; and 5,315,291 to Furr. For whatever reason, each of these patents has failed to alleviate the problem.

In addition, there are a variety of products available on the market today for detecting and stopping water leaks. One such product is a shut-off valve leak sensor for use with washing machines. This product is sold by Watts Water Technologies under the name IntelliFlow™. The IntelliFlow™ shut-off valve includes an A/C powered unit having a water inlet and outlet, and a shutoff valve. It also includes a water sensor placed beneath the washing machine. The sensor transmits a signal to the unit to close the shutoff valve when water is detected beneath the washing machine. Although this product is presumably suitable for its purpose, it is specialized for use with devices which have a “garden-hose” style water connection and which are near an electrical outlet, such as a washing machine. Therefore it cannot be used where many other leaks occur.

There also exists an automatic water shutoff system sold under the name FloLogic® which monitors all water flowing through the main water line into the home. It has a shutoff valve which closes if the unit detects any unusual flow. The FloLogic® is plumbed in line with the water main to the building and automatically shuts off the water supply after the uninterrupted flow of water for a predetermined amount of time. During “home” mode, the amount of time is 30 minutes, and during “away” mode the amount of time is 30 seconds. The flow sensor in the FloLogic® is capable of detecting water flow at less than 1 ounce per minute. While it can detect many leaks, water leaking at a rate of substantially less than 1 ounce per minute is a “slow leak” and can still cause considerable damage when gone undetected for an extended period of time. In addition, while the system is in “home” mode, an undetected severe leak can cause thousands of dollars of damage in well under 30 minutes. This system also requires the user to switch between “home” and “away” modes as they come and go, or even as they go to sleep and wake up. This level of interaction with the system is unduly and burdensome, and it is inevitable that the homeowner would eventually leave the system in “home” mode, thus leaving the home susceptible to damage from severe leaks.

Yet another type of water leak detection system available is sold under the name FloodStop® by OnSite PRO Inc. This system includes four water sensors for placement in various locations about the home, a controller for receiving a wireless signal from the sensors indicating that water is present, and a shutoff valve which is plumbed in line with the water main. When water is detected by any of the sensors, a wireless signal is sent from the respective sensor to the controller, which in turn sends a wireless signal to close the shutoff valve. While this system seems to be an improvement upon the prior art, there remains further opportunities for improvement to expand the applicability of the system and to ensure that the leak is detected and fixed. For instance, the FloodStop® product does not include any means for alerting the homeowner that there is a leak, let alone specifying its location.

Despite these numerous efforts which have been made to detect and stop water leaks in the home, it is evident that further efforts could be made to develop and improve upon these products to truly solve this problem. In addition, there are numerous other dangers which occur in the home for which it would be beneficial to have a detection and alarm system, such as smoke and fire, carbon monoxide, radiation, and more. Even more so, it is desirable to provide an invention which can also provide an early notification system for alerting a user of a problem so that the user can resolve the problem before any further unnecessary damage occurs.

The present invention, as is detailed hereinbelow, seeks to resolve these issues by providing a detection and alarm system which can detect a critical situation (e.g., a water leak), and produce an alarm to notify the homeowner and/or local authorities of the situation.

### SUMMARY OF THE INVENTION

In a first embodiment hereof, the present invention provides a detection and alarm system which generally comprises a sensor for detecting the presence of a critical state, the sensor including means for producing an alarm when the sensor detects the critical state.

In a second embodiment hereof, the present invention provides a detection and alarm system which generally comprises:
(a) at least one sensor configured to produce a first signal when a critical state is detected; and
(b) a monitoring unit including a receiver for receiving the first signal from the sensor, and means for producing an alarm when the receiver receives the first signal.

In a third embodiment hereof, the present invention provides a detection and alarm system which generally comprises:
(a) at least one sensor configured to produce a first signal when a critical state is detected;
(b) a monitoring unit including a receiver and a transmitter, the receiver configured to receive the first signal from the sensor, and the transmitter configured to transmit a second signal when the receiver has received the first signal; and
(c) at least one notification device configured to receive the second signal from the transmitter and produce an alarm to notify a user of the critical state.

Optionally, there can also be provided at least one shutoff valve including a valve plumbed with a supply line. The shutoff valve can include a receiver for receiving the first or second signal, which in turn, instructs the valve to close.

The sensor can be any suitable sensor for detecting any desired critical state, including but not limited to, a water sensor, a smoke and/or fire alarm, a carbon monoxide detector, a radon detector, a sensor for detecting the breaking of glass, a motion detector, a radiation detector, a vibration detector, thermometer, and so forth.

The notification device can be any suitable device for producing or displaying an alarm (audible and/or visible), including but not limited to, a television, a mobile phone, a landline telephone, a computer, an e-book reader, and so forth.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIGS. 1A-1E are various views of a water sensor according to a first embodiment of the present invention hereof;

FIG. 2 is an exploded view of a water sensor;

FIG. 3 is an exploded view of a water sensor having a visual alarm at the end of a flexible wire;

FIG. 4 is an exploded view of a water sensor including a clip for being mounted to a sump pump;

FIG. 5 is an environmental view showing the water sensor with the clip being positioned in the sump pump well for detecting a sump pump failure;

FIG. 6 is a schematic view according to a second embodiment hereof, including various sensors for transmitting the signal to the monitoring unit;

FIG. 7 is a schematic view according to a third embodiment hereof, showing various sensors for transmitting the signal to the monitoring unit and various notification devices for receiving the second signal from the monitoring unit;

FIG. 8 is a schematic view showing various sensors for transmitting the signal to the monitoring unit and the optional shutoff valve;

FIG. 9 is a schematic view showing various sensors, the monitoring unit, notification devices, and the shutoff valve; and

FIGS. 10A-10E show a ring-shaped water sensor for placement around an appliance.

### DETAILED DESCRIPTION OF THE PREFERRED EMBODIMENT

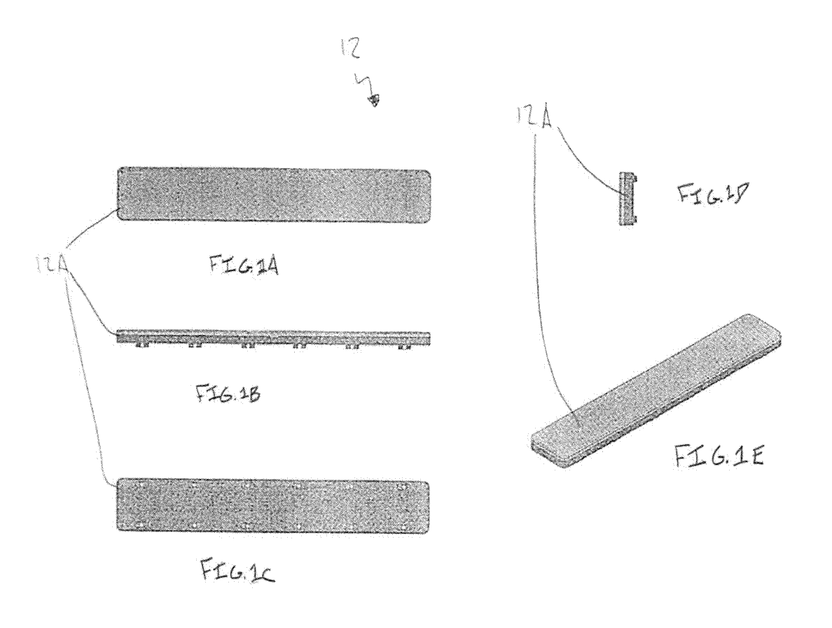

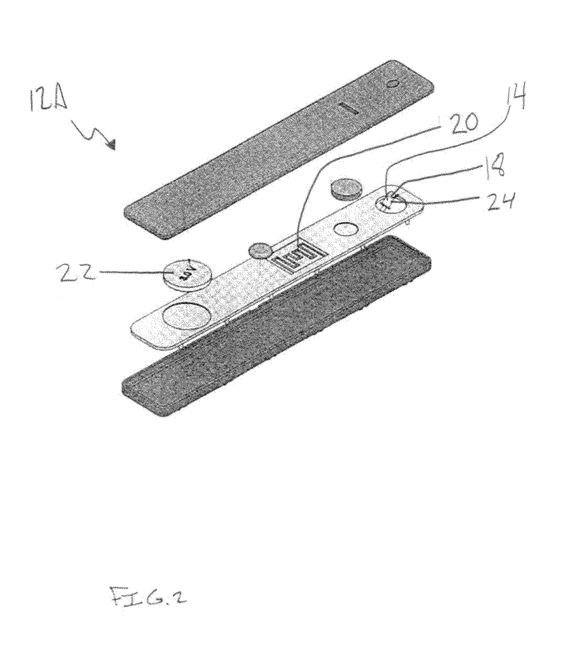

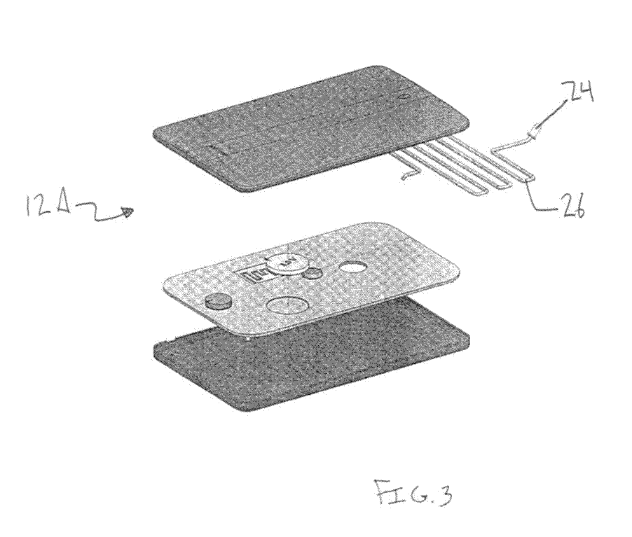

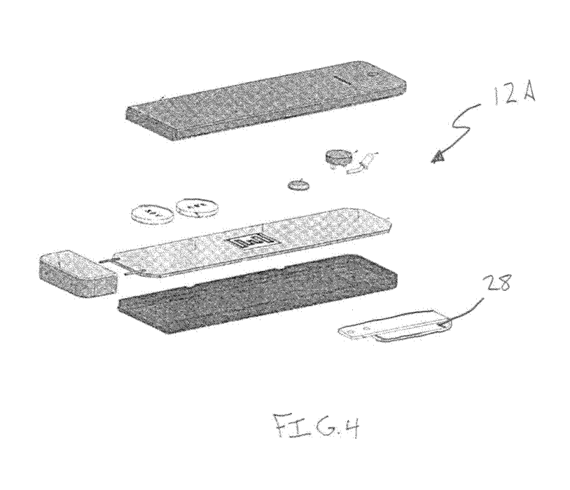

In accordance with a first embodiment of the present invention and as shown generally in FIGS. 1-4, there is a provided a detection and alarm system 10 which generally comprises a sensor 12 for detecting the presence of a critical state in which the sensor 12 includes means for producing an alarm 14 when the sensor 12 detects the critical state.

As referenced throughout, “critical state” is meant to indicate a crisis situation requiring the attention of the user, including but not limited to any of the following: a water leak, rising water levels in a sump pump well, the presence of smoke, the presence of fire, the presence of radiation, the presence of radon, the presence of carbon monoxide, a temperature migrating outside of a preset range, and so forth. For some sensors, such as a carbon monoxide or radon detector, the critical state may be defined as breaching a threshold, or acceptable level. For example, the critical state may be obtained by detecting a concentration in the air over the threshold acceptable level.

The sensor 12 can comprise any suitable type of sensing device or equipment for detecting a critical state. Examples can include, but are not limited to, sensors for detecting water 12A, smoke detectors 12B, fire detectors 12C, carbon monoxide detectors 12D, radon detectors 12E, detectors for detecting the breaking of glass 12F, motion detectors 12G, radiation detectors 12H, vibration detectors 12I, seismic activity detectors (or seismometers) 12J, thermometer 12K, and so forth. The preceding list is only exemplary in nature, and is not intended to be limiting in scope of the present invention in any manner.

The detection and alarm system 10 is preferably used within a building, and even more preferably, inside a house. However, the system can be used in any suitable structure where its benefits are desired. Thus, a suitable sensor could be used to detect any type of critical state which is measurable and would be beneficial to have its presence known. The sensor 12 is positioned at a location in order to detect a critical state at that location. The sensor 12 may, or may not, be located at a position that is remote from a monitoring unit 16 (as described in further detail below).

The sensor 12 includes means for producing an alarm 14 when a critical state is detected. Preferably the alarm 18 is audible and/or visual, and can comprise any suitable device which is well-known by one having ordinary skill in the art and is suitable for use herewith, such as a buzzer, a speaker, an LED light 24, etc.

As show in FIG. 2, when the sensor 12 is a water sensor 12A, it can comprise a printed circuit board 20 having surface mount technology. The sensor 12 can be powered by A/C, but it is preferably D/C-powered and operating from a battery 22. Accordingly, the sensor 12 can include an alarm 18 indicating that battery power is low. Much like a typical smoke alarm, the sensor 12 can produce a first audible alarm sequence when a critical state is detected, and a second audible alarm sequence when a low battery state is detected.

The water sensor 12A can be of the type disclosed in U.S. Pat. Nos. 5,402,075 to Lu et al., and 7,292,155 to Vokey et al., the disclosures of which are hereby incorporated by reference. It is also known that suitable water sensors 12A are commercially available, such as those having a moisture bridge across a sensor contact and which are capable of detecting as little as 1/16^{th} of an inch of water.

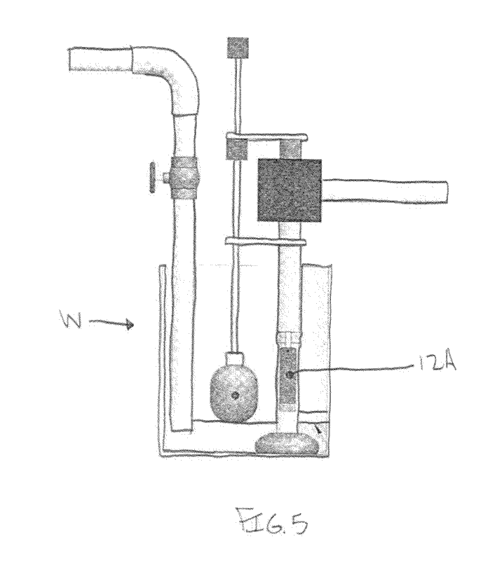

The sensor 12 can also optionally include a transistor, computer chips, or nanoelectronic components. As shown in FIG. 3, when the means for producing an alarm 14 includes a light 24, the light 24 can optionally be disposed at the end of a flexible wire 26 to allow the sensor 12 itself to be placed under an appliance (e.g., a dishwasher), yet allow the light 24 to be positioned in a visible location at the front of the appliance. When provided, the flexible wire 26 is preferably about 18 inches long, although it can be any suitable shape as needed.

The water sensor 12A can comprise any suitable shape which is desirable for use herewith, including an elongated stick, a rectangle, a square, a pentagon, a hexagon, an octagon, a circle, or the like. It is understood that the specific shape of the sensor 12 may be dictated by its placement in the home, manufacturing considerations, design choices, and so forth. It is to be understood that the sensor 12 can be any suitable shape as contemplated by one having ordinary skill in the art.

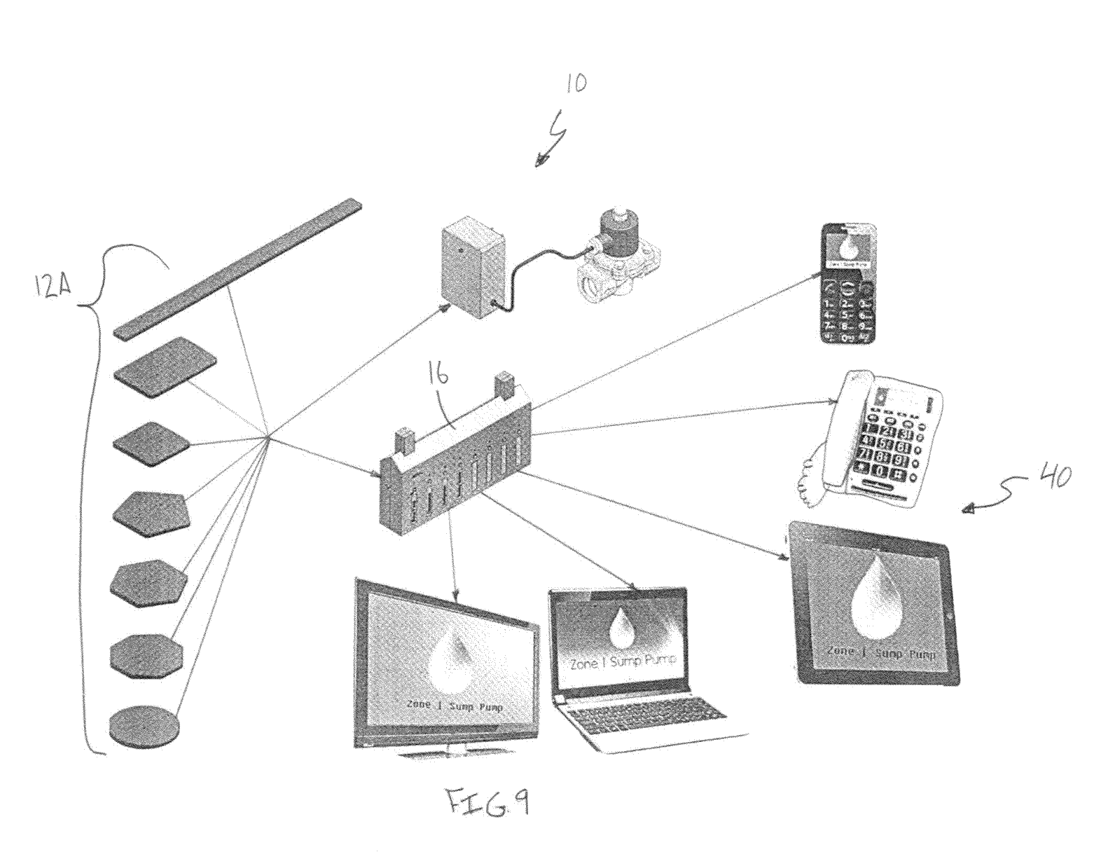

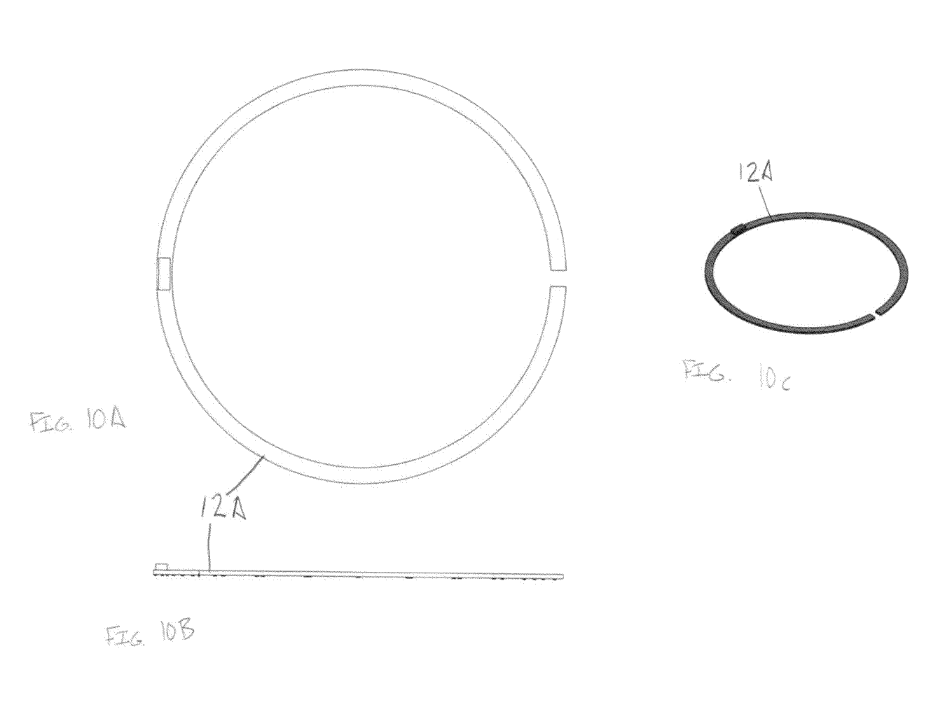

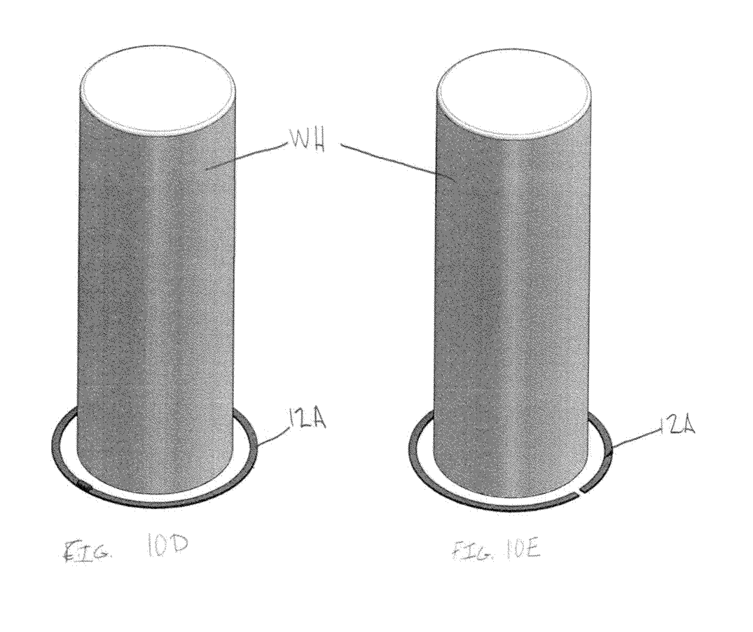

As shown in FIGS. 10A-10E, the water sensor 12A can be a border (or perimeter) strip so that it can be placed around an appliance, such as a water heater WH. The water sensor 12A can be open-looped (see FIG. 10E) or closed-loop (see FIG. 10D). The water sensor 12A strip may also be either rigid or flexible. An open-looped water sensor 12A may be advantageous because it can be positioned around, or under, an existing appliance, and particularly an appliance which may be plumbed or have other connections in place that do not allow a closed-loop sensor to be placed around the appliance. Although the border strip has been shown and described as being placed around an appliance, it is to be understood that the border strip is not limited to use with appliances. Rather, it can be used in any suitable location where it would be desirable to detect the presence of water.

Although the water sensor 12A in FIGS. 10A-10E is shown as being ring-shaped, the water sensor 12A may form the shape of any suitable border or strip around an appliance. For instance, it can form a rectangular border (not shown) for placement around a refrigerator, a dishwasher, a clothes washing machine, or the like. To that end, the water sensor 12A can form a border strip of any suitable, including an oval, a triangle, hexagon, any irregular customized shape, and so forth.

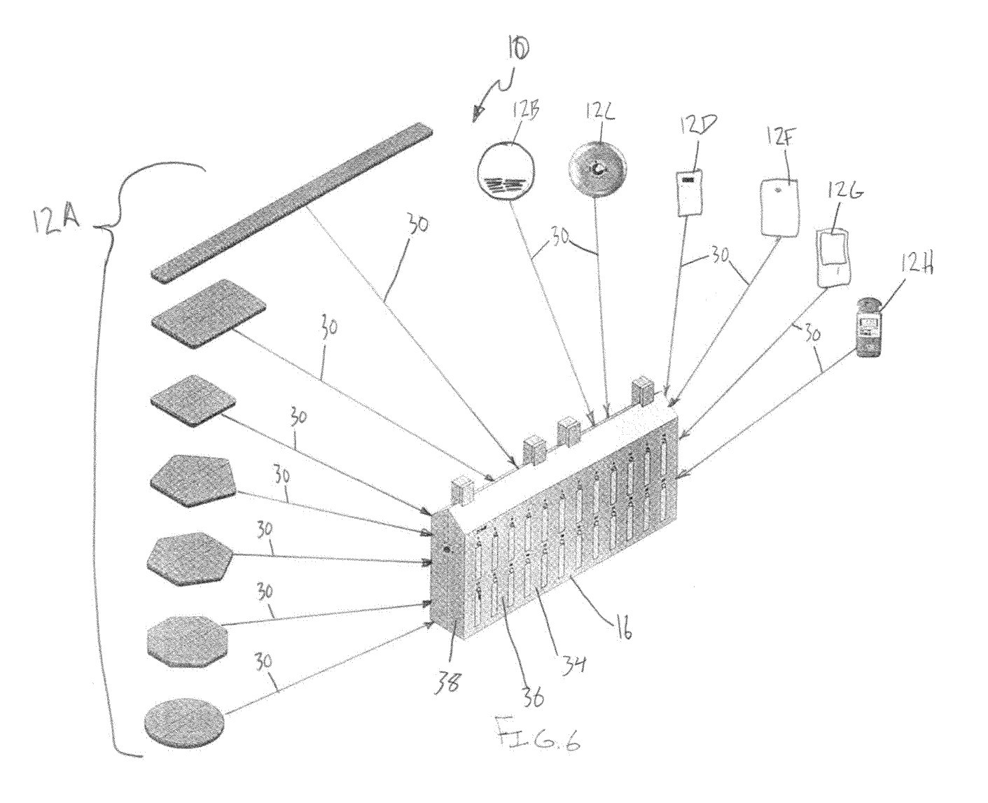

Optionally, and as shown in FIG. 4, the sensor 12 can also be outfitted with a suitable clip 28 or means for retaining so that it can be placed, or hung, in a specific location. For instance, as shown in FIG. 5, the sensor 12 can be hung in a sump pump well W at a specific position to detect when the level of water has risen to an abnormally high level, indicating that the sump pump may have failed and that flooding could occur in the basement.

The sensor component can also comprise any suitable type of device which is well-known in the art and commercially available as an “off-the-shelf” product for detecting a critical state. The “off-the-shelf” sensor component is then wired or configured with the means for producing an alarm 14, as well as any additional circuitry or electronics to enable the sensor 12 to operate as necessary. For instance, there exist “off-the-shelf” sensors for detecting critical states like smoke, fire, water, radiation, radon, carbon monoxide, vibration, temperature, etc.

According to this embodiment, when the sensor 12 detects a critical state, it produces the alarm 18 which can be audible and/or visual. The alarm 18 is then detected by the user, and the user acts accordingly, such as remedying the critical state or fleeing the premises.

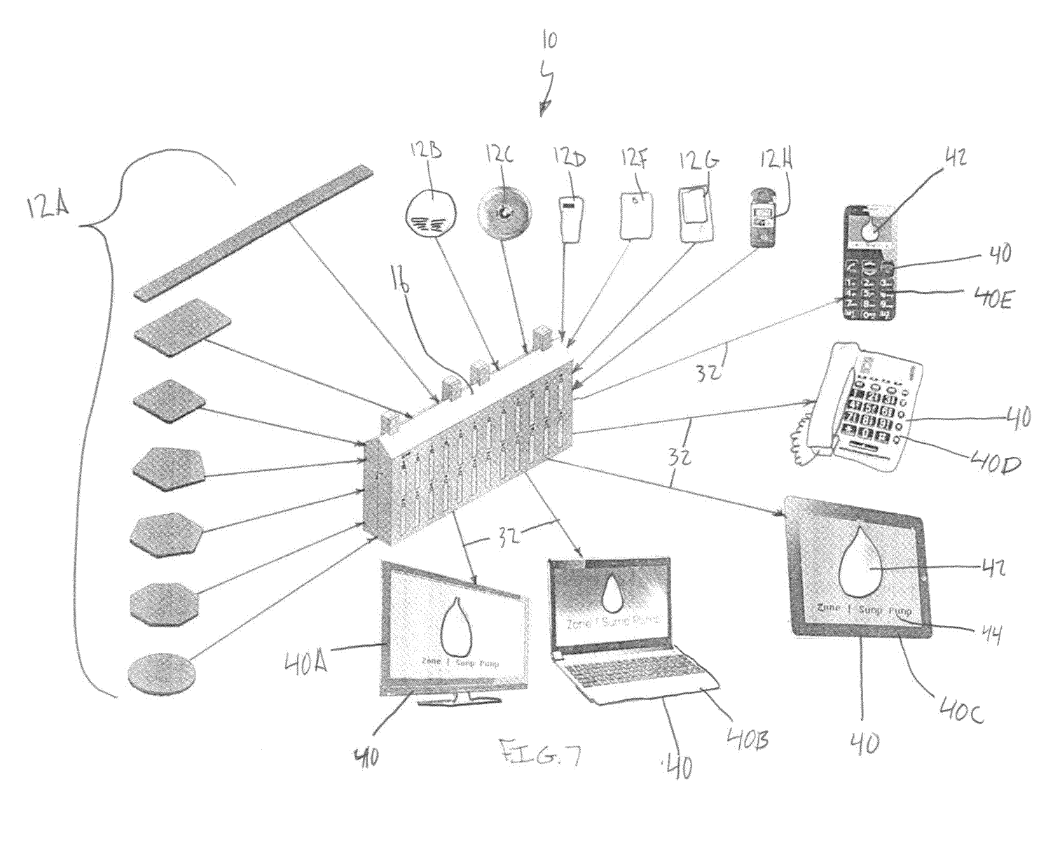

According to a second embodiment of the present invention, and as shown in FIG. 6, there is provided a detection and alarm system 10 which generally comprises: (a) at least one sensor 12 configured to produce a signal 30 when a critical state is detected; and (b) a monitoring unit 16 including a receiver 34 for receiving the signal 30 from the sensor 12, and means for producing an alarm 14 when the receiver 34 receives the first signal 30.

In this embodiment, the sensor 12 does not necessarily include the means for producing an alarm 14, although it optionally still may. The sensor 12 is provided with a suitable component or device for producing a signal 30 when a critical state is detected, such as any suitable type of transmitter 36, including an R/F frequency generator. As discussed in further detail below, the signal 30 can be transmitted to the monitoring unit 16 through a wired connection, but preferably, the signal 30 is transmitted wirelessly. Because it is apparent that the locations of the various sensors 12 are critical, and that a plurality of sensors are preferably disposed in various locations throughout the house or building, a wireless connection is desired for easy installation. The signal 30 is preferably a radio frequency signal 30, although any other type of signal 30 which is suitable for use herewith can be used.

When more than one sensor 12 is provided, preferably each sensor 12 produces its own unique signal 30 (e.g., identifying frequencies or pulse sequences) to identify itself to the monitoring unit 16 so that the identification and location of the critical state is known.

The monitoring unit 16 is a centrally-located unit for receiving the signals 30 from any of the provided sensors 12. The monitoring unit 16 is preferably positioned in a location where it is visible and within earshot of the user. Whenever a sensor 12 produces a signal 30, the monitoring unit 16 receives the signal 30 and produces an alarm 18 which is audible and/or visual. In this regard, the monitoring unit 16 allows each sensor 12 to be monitored from a single location, thereby further ensuring that an alarm 18 does not go unnoticed. Although the monitoring unit 16 is preferably located in a central stationary position, it can have wireless capabilities and be powered by DC-power; therefore it can be portable and carried on the user's person.

The monitoring unit 16 comprises a housing 38, a receiver 34, and means for producing an alarm 14. The housing 38 can comprise any suitable shape and contains the receiver 34 and the means for producing an alarm 14. The housing 38 can be in the shape of a home, such as a stately house, so that it can blend in with surrounding décor and be aesthetically pleasing. On a first side of the housing 38 there can be a plurality of lights 24, such as described in further detail below. On the second side of the housing 38 there can be various switches, buttons, an interface, etc. for configuring the monitoring unit 16 to work in conjunction with the sensors 12

The monitoring unit 16 includes the receiver 34 for receiving the signal 30 from the sensor 12. The receiver 34 can comprise any suitable type of device which is capable of receiving the signal 30.

The monitoring unit 16 can also include means for producing an alarm 14 when the receiver 34 receives the signal 30. Just as with the sensor 12 in the first embodiment, the means for producing an alarm 14 can comprise an audible alarm 18 and/or a visual alarm 18. Because the monitoring unit 16 monitors the status of at least one sensor 12, it can include a plurality of alarms 18, each alarm 18 being associated with a specific sensor 12. Alternatively, the monitoring unit 16 preferably has a single audible alarm 18 intended to alert the user of the critical state, and also a visual alarm 18 (e.g., a light 24) associated with each sensor 12. In this regard, the user is drawn to the monitoring unit 16 by the audible alarm 18, and can look to see which sensor 12 has detected a critical state.

Optionally, the monitoring unit 16 can also report a low or dead battery status for each provided sensor 12. An alarm 18 for low or dead battery status can be distinct from the alarm 18 indicating a critical state.

The monitoring unit 16 is also capable of being configured to receive and properly display the alarm 18 for each sensor 12. This can be accomplished using various programming buttons, accompanying software, or other suitable means. The monitoring unit 16 can be either A/C or D/C-powered. The monitoring unit 16 can also include a suitable “test” function to ensure that the monitoring unit 16 is capable of properly receiving the signal 30 from each sensor 12.

According to a third embodiment of the present invention, and as shown in FIG. 7, there is provided a detection and alarm system 10 which generally comprises: (a) at least one sensor 12 configured to produce a first signal 30 when a critical state is detected; (b) a monitoring unit 16 including a receiver 34 and a transmitter 36, the receiver 34 configured to receive the first signal 30 from the sensor 12, and the transmitter 36 configured to transmit a second signal 32 when the receiver 34 has received the first signal 30; and (c) at least one notification device 40 configured to receive the second signal 32 from the transmitter 36 and produce an alarm 18 to notify a user of the critical state.

Just as with the first signal 30 (or labeled simply as “the signal 30” in the embodiments above), the second signal 32 can comprise any suitable type of signal, such as an electronic signal, a radio frequency signal, a signal that can be sent through a phone modem, a signal that can be sent through the Internet, any combinations thereof, and so forth.

Alternatively, the sensor 12 can send a signal 30 directly to the notification device 40 without relying upon the monitoring unit 16 to receive the first signal 30 from the sensor 12 and then send the second signal 32 to the notification device 40.

Just as with the second embodiment, each sensor 12 may optionally include its own means for producing an alarm 14. Also, according to this embodiment, the monitoring unit 16 does not necessarily include means for producing an alarm 14, but it may optionally.

The notification device 40 can comprise any suitable type of device which can alert the user that a critical state has been detected using visual and/or audible means. The notification device 40 can include any of the following, but is not limited to, a television 40A, a mobile phone 40E, a landline telephone 40D, a desktop computer, a laptop computer 40B, a computing tablet 40C, an e-book reader, a portable music device (e.g., IPod®), and so forth. Preferably, at least one of the notification devices 40 employed by the system 10 is located in close proximity to the user at all times and is capable of quickly and easily attracting the user's attention, as well as waking the user if required.

When the notification device 40 comprises a mobile phone 40E, the mobile phone 40E may be a “smart phone” which operates a software application enabling the mobile phone to access the Internet. Preferably, a smart phone application is operable on the mobile phone 40E which has been developed especially for use with the present invention. The application can include an interface for viewing or monitoring the status of each sensor 12.

The information specifically being provided to and by the notification device 40 is the type of critical state detected (e.g., water leak, smoke, radiation, etc.) and the location of the sensor 12 (e.g., basement, next to the furnace, under the master bathroom sink, dishwasher hot water supply line, etc.). Depending upon the type of sensor 12, the sensitivity of the sensor 12 can vary. For example, a slow water leak it may be necessary to exactly specify which sensor 12 is detecting the leak, however, it is only necessary to know the general location of things like carbon monoxide, radiation, smoke, or fire.

Any suitable means for transmitting the second signal 32 can be provided as well. For instance, when the second signal 32 is sent to a mobile phone 40E to display the alarm 18, the means for transmitting can include a modem (or a cabled or wireless router) for dialing to the phone to transmit the message (e.g., via a voice mail or a SMS text message); an Internet connection (either wired or wireless) for causing the alarm 18 to be displayed by utilizing proprietary web-based software or by notifying a third party (e.g., phone service provider) to send the specific message to the mobile phone 40E; a suitable transmitter 36 to send the second signal 32 directly from the monitoring unit 16 to the notification device 40 via a radio frequency signal or the like; and so forth.

When the notification device 40 is a television 40A, for instance, the second signal 32 can be transmitted to the television 40A by providing a signal receiver (not shown) which is configured with the television 40A such that the signal receiver can receive the second signal 32 and cause the television to display the alarm 18. In another example, the television 40A can be instructed to display the alarm 18 by the cable or satellite service provider. This could be accomplished in which the monitoring unit 16 can access the service provider via the Internet and instruct the service provider to display the proper alarm 18 on the television screen.

It is to be understood by one having ordinary skill in the art that the second signal 32 can be transmitted to the notification device 40 using a variety of means.

Preferably, the alarm 18 comprises an icon which is specific to the sensor 12 which has caused the alarm 18. For instance, if the alarm 18 is caused by a water leak, the alarm 18 can include a large water droplet icon 42, as well as any additional information 44 relevant to the critical state. Accordingly, a flame could be used for fire, a radiation symbol (a/k/a a trefoil) could be used for radiation, and so forth. When the notification device 40 is a mobile phone 40E, a tablet 40C, a laptop 40B, or the like, the alarm 18 can comprise an icon 42 which is enlarged or displayed when the critical state is detected. The user can then select the icon 42 to perform any suitable function, such as display further information 44 about the critical state, minimize the alarm 18 to acknowledge the presence of the critical stage, or even to instruct that certain action be taken (e.g., call 911, shut off a specific supply line, etc.).

In this embodiment, the monitoring unit 16 can include any required devices or ports for transmitting the second signal 32, such as a signal 30 transmitter 36, a modem/phone jack, a LAN port, etc.

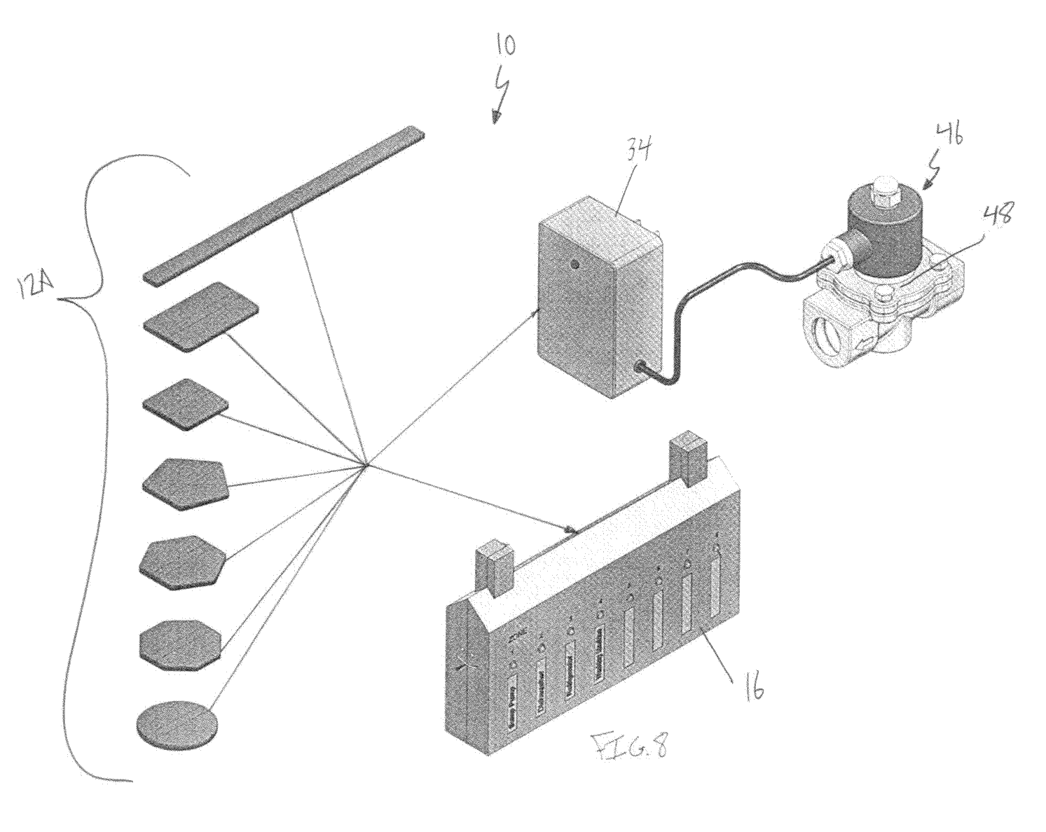

Optionally, and as shown in FIGS. 8 and 9, the invention can also include at least one shutoff valve 46 including a valve 48 plumbed with a supply line (not shown). The shutoff valve 46 also includes a receiver 34 for receiving the signal 30 from the sensor 12 and/or the second signal 32 from the monitoring unit 16 instructing the valve 48 to close. The valve 48 can comprise any suitable type of shutoff valve 46 which can be closed with an electrical signal 30, such as a solenoid valve. Thus, if a water leak is detected, the sensor 12 can transmit a signal 30 to the shutoff valve 46, either directly or via the monitoring unit 16, instructing the shutoff valve 46 to close the supply line.

Optionally, a plurality of shutoff valves 46 can be provided, each being plumbed at a location specific to particular regions of the building, to a specific room, or even to a specific appliance or plumbing fixture. In this regard, it is possible to associate specific sensors 12A,12B, etc. with specific shutoff valve 46s to ensure that, for example, a water leak to the refrigerator results in closing the shutoff valve 46 associated with that appliance or room, thereby reducing the negative impact of the leak on the non-offending portions of the house.

It is noted that the shutoff valve 46 does not need to be plumbed in line specifically with a water supply line. Any other suitable supply line can be suitable for use herewith, for example, a gas supply line. Thus, the system can be configured so that the gas line to the building is closed when smoke or fire is detected. In addition, a vibration, or seismic, sensor can be used to detect an earthquake, causing the gas line to be shut off. It is known that explosive gas leaking from buildings following an earthquake can be an additional hazard to deal with. Indeed, it is believed that about half of fires in building following earthquakes are caused by ignited gas which has leaked from broken supply lines.

In use, the system can be customizable and configurable as needed by the user to detect any suitable critical state within the structure. In particular, the smoke and fire alarms 18 can obviously be used to alert a homeowner to the presence of these conditions whether they are asleep in their bed in the house, away at work, or out of town. Carbon monoxide and radon detectors can be placed in the basement and/or close to critical appliances (e.g., a furnace) to detect the critical states. Carbon monoxide is known as a silent killer because its presence is often unknown until it is too late. Likewise, radon is the second leading cause of lung cancer in the United States. But it is not detectable by sight or smell, and as a result people often unknowingly live with radon in their home for years before developing cancer. Furthermore, a motion sensor and/or a sensor for detecting the sound of breaking glass can be used as a security system.

The thermometer sensor can also be used to monitor the temperature of specific appliances (e.g., a basement freezer), rooms, or the entire building/house. In particular, the temperature of an entire house can be monitored. When it is desired to monitor the temperature of an entire building or home, the thermometer sensor can comprise the thermostat for controlling the heat or air conditioning. Likewise, the thermometer sensor can also comprise an appliance's thermostat (e.g., refrigerator, freezer, etc.). This has applicability when a home is vacant for extended periods of time, such as unoccupied rentals or a user's seasonal home which is unoccupied for weeks or even months at a time. In this regard, the user can be notified when the ambient temperature in the home drops below a set temperature for set period of time, thereby indicating that the heating system may not be working properly. Thus, this alarm 18 provides the user an opportunity to address the problem before the temperature drops to a level where pipes can freeze and burst Likewise, appliances such as a freezer can be monitored to ensure that it is working properly, or that it is closed properly, before the temperature rises and the contents spoil.

In addition, in the wake of the Japanese tsunami and resulting nuclear disaster in 2011, it is anticipated that a number of radioactive components may be sold on the black market and ultimately make their way into products which are sold to unaware consumers and then enter people's homes. It is apparent that homes typically do not have a radiation detector, and thus they are left defenseless to detecting this potential danger. When the system is equipped with a radiation sensor, it provides a means of defense for detecting this critical situation and allowing it to be eliminated before severe health issues may be encountered.

Therefore, it is seen that the system can be configured as a multifaceted sensor and alarm system for detecting not only costly situations such as water leaks, but also many other security and safety issues as well. In this regard, the present invention provides an early notification system for alerting the user of the critical state, thereby minimizing the amount of damage that would have occurred, if not even avoiding the damage altogether. In cases of fire, carbon monoxide, radon, or break-ins, the present invention can even save the user's life.

In some applications, it may be desirable to have the sensor 12 housed either in or on the notification device 40, rather than at a remote location. The sensor 12 can be provided as a component which can be secured to the notification device 40 as an “aftermarket” feature by the user, or it can be installed either on or in the notification device 40 by a manufacturer. For instance, this may be desired when the sensor 12 is of the type which can detect radiation. Thus, the sensor 12 can be housed in devices such as mobile phones, landline phones, eBooks, IPod's®, laptop computers, desktop computers, televisions, automobile PCB enclosures, and the like. The sensor 12 can then be used to ensure that the particular notification device 40 is free from radiation. When the notification device 40 is mobile and carried on the user's person, such as a mobile phone or an IPod®, the sensor 12 can then be used to detect any surrounding radiation as the user goes about their day and moves throughout their environment, and particularly throughout their home and car.

As is apparent from the preceding, the present invention provides a detection and alarm system which can detect a critical situation (e.g., a water leak), and produce an alarm to notify the homeowner and/or local authorities of the situation to minimize or eliminate the potential for loss of life and damage to personal property, government buildings, real estate, and so forth.

What is claimed is:

1. A detection and alarm system comprising:
(a) at least one sensor configured to produce a first signal when a critical state is detected; and
(b) a monitoring unit positioned at a remote location from the at least one sensor, the monitoring unit including a receiver for receiving the first signal from the sensor, and means for producing an alarm when the receiver receives the first signal.

2. The detection and alarm system of claim 1 wherein the at least one sensor is selected from a group consisting of a water sensor, a smoke alarm, a fire alarm, a carbon monoxide detector, a radon detector, a sensor for detecting the breaking of glass, a motion detector, a radiation detector, a vibration sensor, a seismic sensor, and a thermometer.

3. The detection and alarm system of claim 2 wherein the critical state is defined as:
(a) the presence of water when the sensor is a water sensor;
(b) the presence of smoke when the sensor is a smoke alarm;
(c) the presence of fire when the sensor is a fire alarm;
(d) the presence of a threshold level of carbon monoxide when the sensor is a carbon monoxide detector;
(e) the presence of a threshold level of radon when the sensor is a radon detector;
(f) glass being shattered when the sensor is for detecting the breaking of glass;
(g) the presence of motion when the sensor is a motion detector;
(h) the presence of a threshold level of radiation when the sensor is a radiation detector;
(i) the presence of a threshold level of vibration when the sensor is a vibration sensor;
(j) the presence of a threshold level of seismic activity when the sensor is a seismometer; and
(k) the presence of a threshold temperature level when the sensor is a thermometer.

4. The detection and alarm system of claim 1 including at least one shutoff valve having a valve and a receiver, the valve being plumbed with a supply line, and the receiver provided for receiving the first signal from the sensor, wherein the valve is closed when the receiver receives the first signal.

5. The detection and alarm system of claim 2 including at least one shutoff valve having a valve and a receiver, the valve being plumbed with a supply line, and the receiver provided for receiving the first signal from the sensor, wherein the valve is closed when the receiver receives the first signal.

6. A detection and alarm system comprising:
(a) at least one sensor configured to produce a first signal when a critical state is detected;
(b) a monitoring unit including a receiver and a transmitter, the receiver configured to receive the first signal from the sensor, and the transmitter configured to transmit a second signal when the receiver has received the first signal; and
(c) at least one notification device configured to receive the second signal from the transmitter and produce an alarm to notify a user of the critical state.

7. The detection and alarm system of claim 6 wherein the at least one sensor is selected from a group consisting of a water sensor, a smoke alarm, a fire alarm, a carbon monoxide detector, a radon detector, a sensor for detecting the breaking of glass, a motion detector, a radiation detector, a vibration sensor, a seismic sensor, and a thermometer.

8. The detection and alarm system of claim 6 wherein the critical state is defined as:
(a) the presence of water when the sensor is a water sensor;
(b) the presence of smoke when the sensor is a smoke alarm;
(c) the presence of fire when the sensor is a fire alarm;
(d) the presence of a threshold level of carbon monoxide when the sensor is a carbon monoxide detector;
(e) the presence of a threshold level of radon when the sensor is a radon detector;
(f) glass being shattered when the sensor is for detecting the breaking of glass;
(g) the presence of motion when the sensor is a motion detector;
(h) the presence of a threshold level of radiation when the sensor is a radiation detector;
(i) the presence of a threshold level of vibration when the sensor is a vibration sensor;
(j) the presence of a threshold level of seismic activity when the sensor is a seismometer; and
(k) the presence of a threshold temperature level when the sensor is a thermometer.

9. The detection and alarm system of claim 6 including at least one shutoff valve having a valve and a receiver, the valve being plumbed with a supply line, and the receiver provided for receiving the first signal from the sensor, wherein the valve is closed when the receiver receives the first signal.

10. The detection and alarm system of claim 7 including at least one shutoff valve having a valve and a receiver, the valve being plumbed with a supply line, and the receiver provided for receiving the first signal from the sensor, wherein the valve is closed when the receiver receives the first signal.

11. The detection and alarm system of claim 6 wherein the at least one notification device is selected from a group consisting of a television, a mobile phone, a landline telephone, a desktop computer, a laptop computer, a computing tablet, an e-book reader, and a portable music device.

12. The detection and alarm system of claim 7 wherein the at least one notification device is selected from a group consisting of a television, a mobile phone, a landline telephone, a desktop computer, a laptop computer, a computing tablet, an e-book reader, and a portable music device.

13. The detection and alarm system of claim 9 wherein the at least one notification device is selected from a group consisting of a television, a mobile phone, a landline telephone, a desktop computer, a laptop computer, a computing tablet, an e-book reader, and a portable music device.

14. The detection and alarm system of claim 10 wherein the at least one notification device is selected from a group consisting of a television, a mobile phone, a landline telephone, a desktop computer, a laptop computer, a computing tablet, an e-book reader, and a portable music device.

15. The detection and alarm system of claim 6 wherein the notification device comprises a mobile phone and the monitoring device includes a modem for transmitting the second signal to the mobile phone.

16. The detection and alarm system of claim 6 wherein the notification device comprises a mobile phone operating an Internet-accessible software application, and the monitoring device is connected to the Internet, and whereby the second signal is transmitted from the monitoring device to the mobile phone via the Internet.

17. The detection and alarm system of claim 7 wherein the notification device comprises a mobile phone operating an Internet-accessible software application, and the monitoring device is connected to the Internet, and whereby the second signal is transmitted from the monitoring device to the mobile phone via the Internet.

18. The detection and alarm system of claim 9 wherein the notification device comprises a mobile phone operating an Internet-accessible software application, and the monitoring device is connected to the Internet, and whereby the second signal is transmitted from the monitoring device to the mobile phone via the Internet.
